(19) United States
(12) Patent Application Publication
(10) Pub. No.: US 2010/0323152 A1
(43) Pub. Date: Dec. 23, 2010

(54) CHRISTMAS ORNAMENT TAGS AND METHOD OF IDENTIFYING CHRISTMAS ORNAMENTS

(76) Inventor: AMELIA BRUMLEY, ROCKPORT, IN (US)

Correspondence Address: LAW OFFICE OF JERRY D. HAYNES , P.A, P.O. Box 350392, Fort Lauderdale, FL, 33335, US

(21) Appl. No.: 12/488,650

(22) Filed: Jun. 22, 2009

(51) Int. Cl. B32B 3/04; B23P 11/00

(52) U.S. Cl. 428/121; 29/428

(57) ABSTRACT

The present invention relates to an ornament tag comprising: a first position that includes a uniform shape that includes two mirror sides about a centerline; a second position, where said tag is folded about the centerline and the two mirror sides are aligned; a writing surface on at least one side of the tag when in the second position; and an attachment string, where said string permanently attaches the tag to a Christmas ornament. The uniform shape may include a mitten shape, a candy cane shape or a Christmas tree shape. The tag may be made of tin, aluminum or copper. In one exemplary embodiment, the tag has the dimensions of about 5 cm by about 2 cm to 3 cm. The present invention further includes a method of identifying a Christmas ornament utilizing the ornament tag according to the present invention.

### BACKGROUND OF THE INVENTION

1. Field of Invention

The present invention relates to a device, tag that is utilized to label Christmas tree ornaments.

2. Description of Related Art

Millions of people celebrate Christmas each year around the world. One traditional component of the Christmas holidays includes displays and decoration of Christmas trees. Christmas trees are usually adorned with lights, ornaments and tinsel along with other decorating material.

On occasion ornaments are given to people as a gift and therefore may attach a special meaning for a particular ornament. People normally store ornaments after the Christmas holidays for use in following years. As stated some ornaments may have special meanings maybe associated with anniversaries, childbirth or even a limited edition associated with particular Christmas ornaments designs. Over the years Christmas ornaments may accumulate and consequently an individual family may have dozens of ornaments to actually choose from each year as part of their Christmas tree display.

After accumulation of a significant number of ornaments individuals may have trouble determining the source of the ornament and are unable remember if the ornament was purchased or given as a gift. It would therefore be advantageous to have a means to identify Christmas ornaments as received and to identify the source thereof.

### SUMMARY OF THE INVENTION

The present invention relates to an ornament tag comprising: a first position that includes a uniform shape that includes two mirror sides about a centerline; a second position, where said tag is folded about the centerline and the two mirror sides are aligned; a writing surface on at least one side of the tag when in the second position; and an attachment string, where said string provides a means to permanently attach the tag to a Christmas ornament. The uniform shape may include a mitten shape, a candy cane shape or a Christmas tree shape. The tag may be made of tin, aluminum or copper. In one exemplary embodiment, the tag has the dimensions of about 5 cm by about 2 cm to 3 cm. The present invention further includes a method of identifying a Christmas ornament comprising the steps of: providing a writing surface on a tag; indicating information on said writing surface; and permanently attaching said tag onto a Christmas ornament. The information may identify the source of the Christmas ornament.

### BRIEF DESCRIPTION OF DRAWINGS

FIG. 1A depicts a Christmas ornament tag according to the present invention.

FIG. 1B depicts the Christmas ornament tag of FIG. 1A in an open position.

FIG. 2A depicts another exemplary ornament tag according to the present invention.

FIG. 2B depicts the ornament tag of FIG. 2A in an open position.

FIG. 3A depicts another exemplary ornament tag according to the present invention.

FIG. 3B depicts the ornament tag of FIG. 3A in an open position.

### DETAILED DESCRIPTION

The present invention relates to an ornament tag that is used to label Christmas tree ornaments in order to identify the source thereof. Christmas ornaments accumulate over the years and many people develop an entire collection of Christmas ornaments that may be utilized throughout the Christmas holidays. The present invention provides a tag system and device that enables the user to tag Christmas ornaments and identify the source of the Christmas ornament.

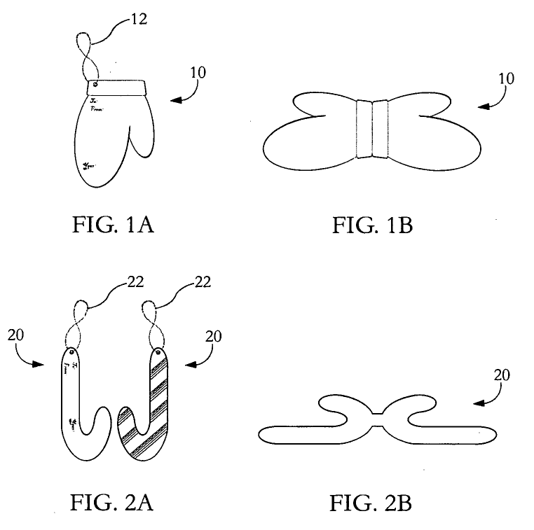

The ornament tags according to the present invention may be designed in various shapes and sizes that are commonly associated with the Christmas holidays. FIG. 1A depicts an exemplary tag according to the present invention. Christmas ornament tag 10 is shown which includes an attachment string 12. The Christmas ornament tag 10 is shaped like a hand mitten and provides a writing surface for an individual to indicate information associated with the ornament. The attachment string 12 attaches securely to the Christmas ornament, which normally includes a hook and a loop device that may receive the attachment string 12. The ornament tag 10 may be attached to any desired ornament either by the giver of the ornament or after receiving the gift by the recipient of the ornament.

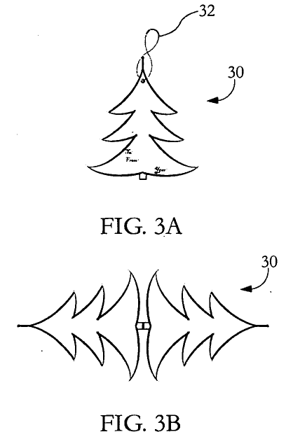

The ornament tag according to the present invention may be produced in an open position as depicted in FIG. 1B. The ornament tag 10 is shown in an open position whereas the tag is closed about a centerline and attachment string 12 is attached to the tag for hanging with the ornament. Other exemplary embodiments of the present invention are depicted in FIGS. 2A and 3A. FIG. 2A depicts a candy cane design of the ornament tag according to the present invention. The ornament tag 20 includes attachment cord 22. The ornament tag 20 is shown in the open position in FIG. 2B and as noted the open position may be closed about the centerline of the ornament tag.

FIG. 3A depicts yet another exemplary embodiment of the ornament tag according to the present invention. Ornament tag 30 is shown with attachment cord 32. The ornament tag 30 provides a Christmas tree design for the ornament tag and functions in a manner similar to the above-discussed embodiments. The ornament tag 30 folds about a center line as depicted in FIG. 3B and closes for attachment to an ornament by using the ornament attachment cord 32.

The ornament tag provides individuals with decorative identification tags that enable individuals to identify the source of ornaments received or purchased during the Christmas holidays. These decorative identification tags provide several alternatives for individuals in storing and organizing Christmas ornaments. The material used to manufacture the ornament tags may be tin, aluminum or copper that can be attached by using the attachment string as noted in the embodiments disclosed in this application. The users may write upon these tags, which include a suitable writing surface to identify pertinent information associated with each Christmas ornament. Although three specific designs are depicted in this application numerous designs may be implemented using the structure as disclosed above. The ornaments fold about a centerline and close for attachment with an attachment cord. Some exemplary sizes may include tags of about 5 centimeters by 2 to 3 centimeters and made of durable material as noted above.

What is claimed is:

1. An ornament tag comprising:
a. a first position that includes a uniform shape that include two mirror sides about a centerline;
b. a second position, where said tag is folded about the centerline and the two mirror sides are aligned;
c. a writing surface on at least one side of the tag when in the second position; and
d. an attachment string, where said string provides a means to permanently attach the tag to a Christmas ornament.

2. The ornament tag according to claim 1, where the uniform shape includes at least one of a mitten shape, a candy cane shape and a Christmas tree shape.

3. The ornament tag according to claim 1, where said tag is made of at least one of tin, aluminum and copper.

4. The ornament tag according to claim 1, where said tag has the dimensions of about 5 cm by about 2 cm to 3 cm.

5. A method of identifying a Christmas ornament comprising the steps of:
a. providing a writing surface on a tag;
b. indicating information on said writing surface; and
c. permanently attaching said tag onto a Christmas ornament.

6. The method according to claim 5, where said information identifies the source of the Christmas ornament.

7. The method according to claim 5, where the tag is made of at least one of tin, aluminum and copper.

8. The method according to claim 5, where the tag has the dimensions of about 5 cm by about 2 cm to 3 cm.
